(19) United States
(12) Patent Application Publication
(10) Pub. No.: US 2010/0314415 A1
(43) Pub. Date: Dec. 16, 2010

(54) HANDS-FREE HYDRATION SYSTEM FOR NON-AMBULATORY USERS

(76) Inventor: Sarah Carter, (US)

Correspondence Address: Paula J. Yost, 4930 Sunburst Lane, Charlotte, NC, 28213, US

(21) Appl. No.: 12/815,376

(22) Filed: Jun. 14, 2010

Related U.S. Application Data
(60) Provisional application No. 61/268,575, filed on Jun. 15, 2009.

(51) Int. Cl. A45F 3/16; B67D 7/06; A47G 19/22

(52) U.S. Cl. 222/183; 220/705; 224/148.2

(57) ABSTRACT

An oral hydration system for supplying user, such as patients, who are unable to lift a glass or a pitcher with hydrating fluids. The hydration system includes a holster that holds a fluid container which is closed by a removable cap. The holster is configured to be easily removably installed into various health care or residential configurations, such as on an intravenous (IV) pole, a wheelchair, a wall hook, a hospital bed, or worn by a user. A hydrating tube extends from the fluid container to a mouthpiece. Beneficially the mouthpiece enables a user to control hydration, such as by biting. The hydration system further includes a scale for indicating how much fluid remains in the system and/or how much fluid a user has ingested. To assist an operator use the hydration system that system includes a window for viewing the scale, a removable cap for refilling the hydration system, and in some applications a drain plug for removing liquid when the hydration system is in-situ.

This application claims priority to U.S. Provisional Application No. 61/268,575, filed on Jun. 15, 2009.

### TECHNICAL FIELD

The presently disclosed subject matter is directed towards a hands-free hydration system suitable for use by non-ambulatory users, and more particularly towards a a hands-free, oral hydration system suitable for patients who are unable to use a glass or a pitcher.

### BACKGROUND

Infirm persons often struggle with maintaining adequate hydration. For example, there are many patients that have difficulty with lifting a glass or a pitcher to drink hydrating fluids.

Inadequate hydration can lead to problems such as electrolyte imbalances, low blood pressures, decreased skin elasticity, discomfort, and even death. Infirm persons, including the elderly or persons who reside in assisted living facilities, are particularly at risk of inadequate hydration. While inadequate hydration can be obtained via intravenous (IV) fluids, such methods require costly skilled personnel and can expose infirm persons to infection risks as well as causing unnecessary pain due to the invasive nature of the intravenous (IV) insertion.

Accordingly, there remains a need for an easier, less invasive alternative to aid infirm persons with hydration.

### SUMMARY

An oral hydration system for supplying user, such as patients, who are unable to lift a glass or a pitcher with hydrating fluids. The hydration system includes a holster that holds a fluid container which is closed by a removable cap. The holster is configured to be easily removably installed into various health care or residential configurations, such as on an intravenous (IV) pole, a wheelchair, a wall hook, a hospital bed, or worn by a user. A hydrating tube extends from the fluid container to a mouthpiece. Beneficially the mouthpiece enables a user to control hydration, such as by biting. The hydration system further includes a scale for indicating how much fluid remains in the system and/or how much fluid a user has ingested. To assist an operator use the hydration system that system includes a window for viewing the scale, a removable cap for refilling the hydration system, and in some applications a drain plug for removing liquid when the hydration system is in-situ.

### BRIEF DESCRIPTION OF THE DRAWINGS

The foregoing summary, as well as the following detailed description of preferred embodiments, is better understood when read in conjunction with the appended drawings. For the purposes of illustration, there is shown in the drawings several exemplary embodiments; however, the presently disclosed subject matter is not limited to the specific methods and instrumentalities disclosed. In the drawings:

FIG. 1 is a perspective view of a hydration system 10, according to a preferred embodiment of the present invention;

FIG. 2 is a perspective view a fluid container 30 for the hydration system 10, according to a preferred embodiment of the present invention,

FIG. 3A is an environmental view of the hydration system 10 removably installed hereonto an intravenous pole 61, according to a preferred embodiment of the present invention;

FIG. 3B is an environmental view of the hydration system 10 removably installed hereonto a wall hook 62, according to a preferred embodiment of the present invention;

FIG. 3C is an environmental view of the hydration system 10 removably installed hereonto a wheelchair 63, according to a preferred embodiment of the present invention;

FIG. 3D is an environmental view of the hydration system 10 removably installed hereonto a side rail of a hospital bed 64, according to a preferred embodiment of the present invention;

FIG. 3E is an environmental view of the hydration system 10 removably attached hereonto a harness 66 worn by a wearer 65, according to a preferred embodiment of the present invention;

FIG. 4A is a perspective view of an alternate fluid container 40 for the hydration system 10, with the alternate fluid container 40 depicted in an empty state, according to an alternate embodiment of the present invention; and

FIG. 4B is a perspective view of the alternate fluid container 40 depicted in a fluid filled state, according to the alternate embodiment of the present invention.

### DETAILED DESCRIPTION

### 1. Description of the Figures

The presently disclosed subject matter will be described more fully hereinafter with reference to the accompanying drawings, in which some, but not all embodiments are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

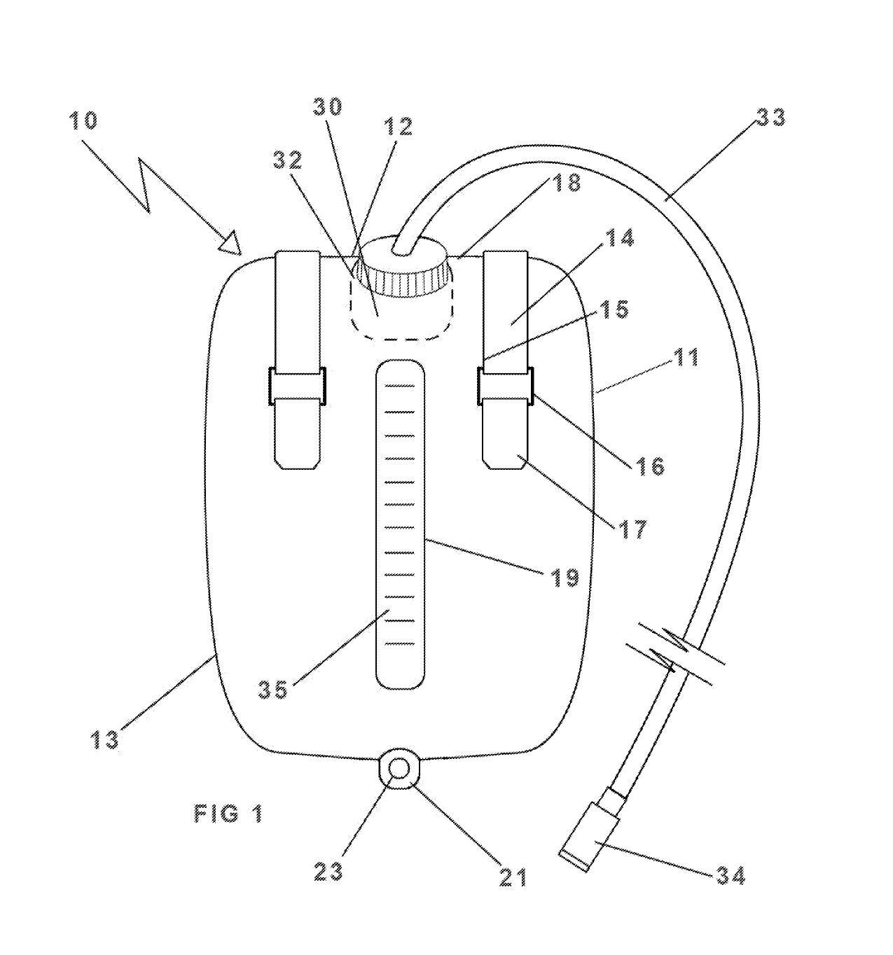

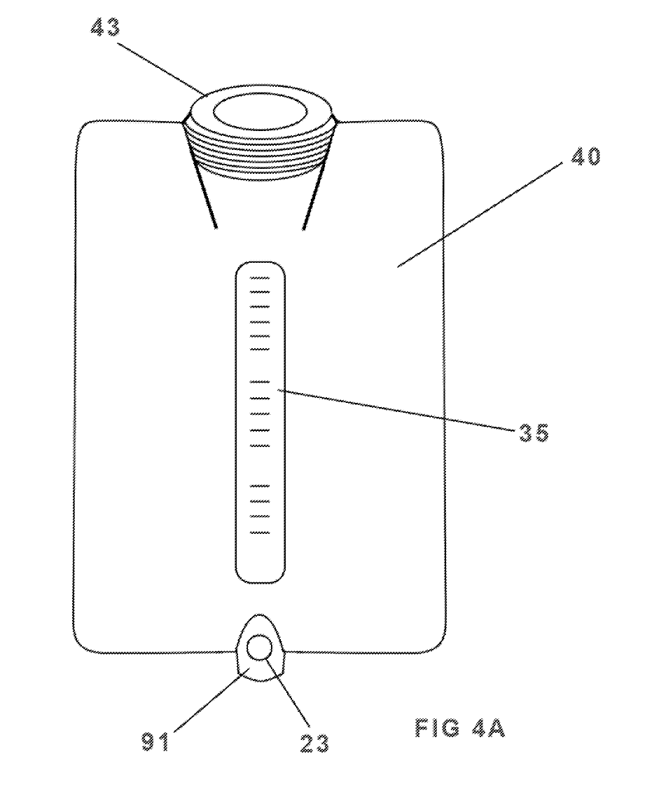

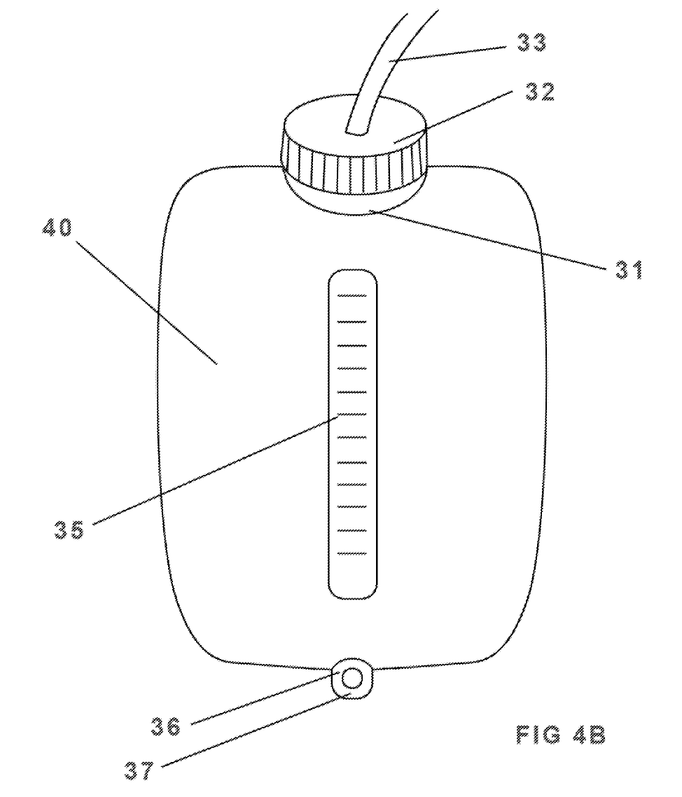

The best mode for carrying out the invention is presented in terms of its preferred embodiment, herein depicted within FIGS. 1 through 3E, and in terms of an alternate embodiment, herein depicted within FIGS. 4A and 4B. However, the invention is not limited to the described embodiments, and a person skilled in the art will appreciate that many other embodiments are possible without deviating from the principles of the present invention and that any such embodiment will also fall within the scope of this invention. It is envisioned that other styles and configurations of the present invention can be easily incorporated into the teachings of the present invention, and that the disclosed configurations are shown and described for purposes of clarity and disclosure, and not by way of limitation of scope.

The terms “a” and “an” herein do not denote a limitation of quantity, but rather denote the presence of at least one of the referenced items.

The present invention describes a hydration system, (herein described as the “hydration system”) 10, which provides a means for hydrating non ambulatory users, many of which may be unable to reach for and use a pitcher or a drinking glass.

Referring now to FIG. 1, which is a perspective view of the hydration system 10 according to the preferred embodiment of the present invention, the hydration system 10 comprises a holster 11 that defines a contained volume for retaining and enclosing a container 30 which contains a fluid, such as water or other medicinal liquid. That fluid is deliverable to a user by way of a hydrating tube 33 that ends in a mouthpiece 34. Beneficially the mouthpiece 34 is of the type that opens when bitten by a user. The holster 11 comprises an upper portion 12 and a lower portion 13, a pair of first straps 14, a pair of buckles 16, and a pair of second straps 17.

The holster 11 also includes both a window 19 and an aperture 18. The window 19 provides a caregiver to easily read a scale 35 (subsequently described in more detail) that shows how much fluid is in the container 30. The aperture 18 allows passage of fluid from the container 30 to the hydrating tube 33 while supporting installation of the container 30 within the holster 11.

The upper portion 12 of the holster 11 is hingedly attached thereonto a rear exterior portion of the holster 11, thereby allowing the upper portion 12 to be opened and the container 30 to be installed hereinto the holster 11 and its contained volume. After installing the container 30 hereinto the holster 11, the upper portion 12 is closed hereagainst the lower portion 13 of the holster 11, wherein the closed state is secured by the first straps 14 and corresponding buckles 16, wherein each first strap 14 is looped through a corresponding buckle 16, closed hereonto itself and secured by fastening a closure 15 comprising a hook-and-loop configuration. Each buckle 16 is retained by a corresponding second strap 17 that is looped through a buckle 16 and permanently fastened, by means such as chemical bonding, sewing or riveting, hereonto a front exterior face portion of the holster 11. The holster 11 and the straps 16 and 17 are beneficially made of canvas, nylon, or an eco-friendly plastic material, while the buckles 16 are beneficially stainless steel.

It should be clearly understood that while the upper portion 12 is described as being closed against the lower portion 13 using buckles and straps, such description is for explanation, not limitation. For example, Velcro straps and patches may be advantageous in some applications, snaps in others, and zippers in yet others. Furthermore, other methods of obtaining an enclosing volume for the container 30 are possible, for example, the use of an elastic sleeve. In any event the holster 11 has a defined front and back.

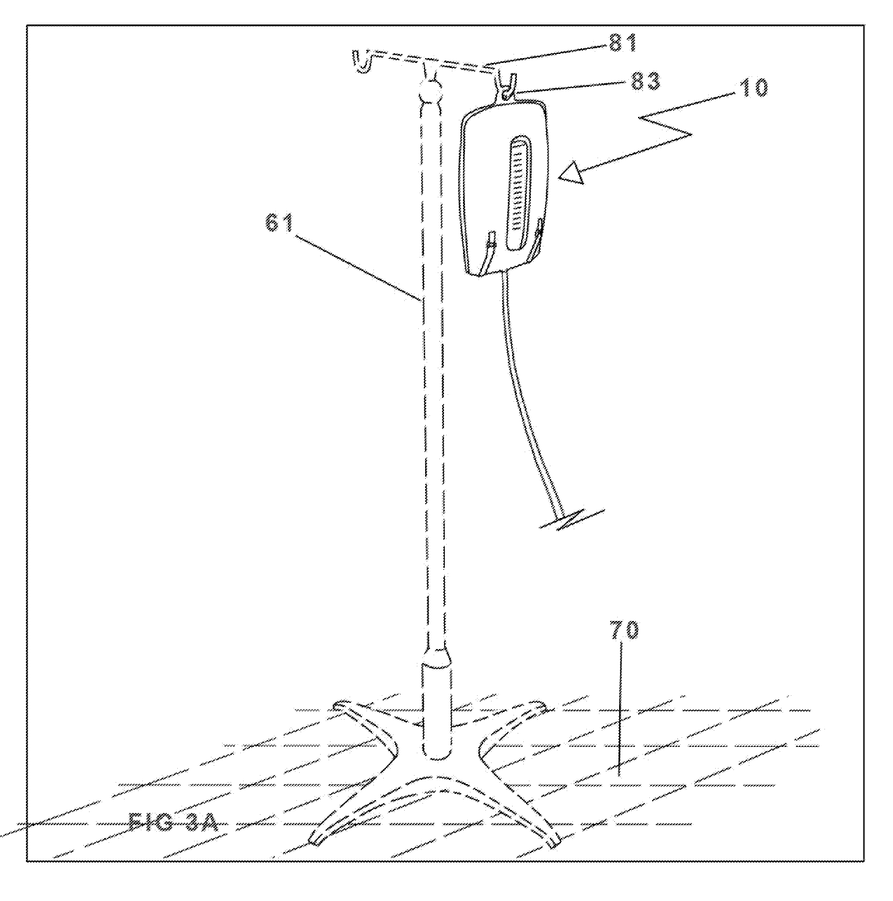

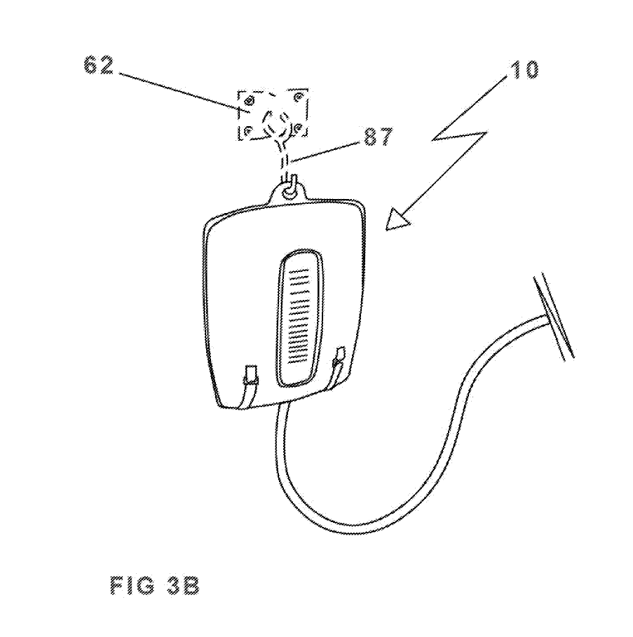

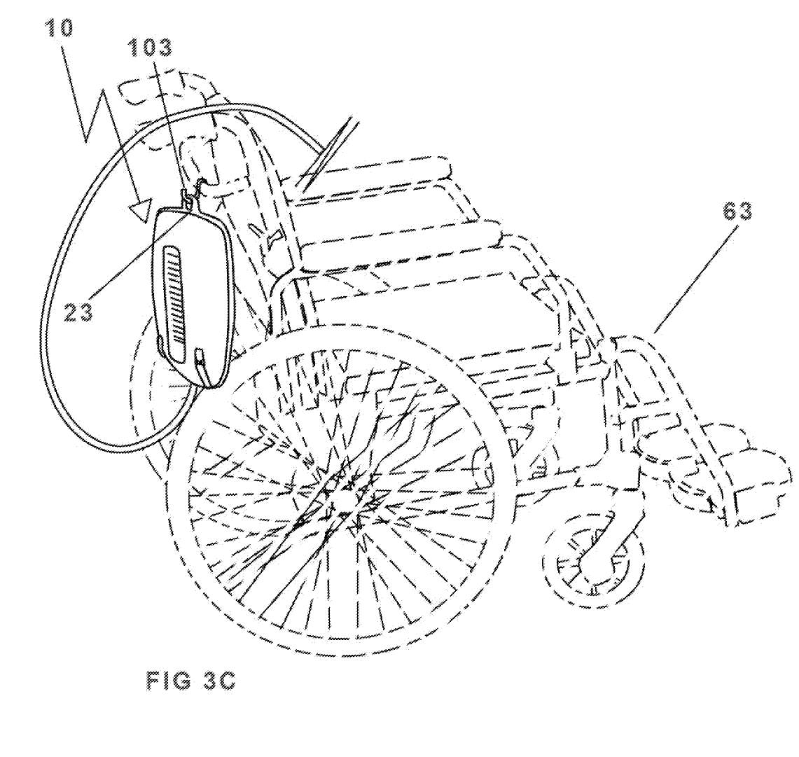

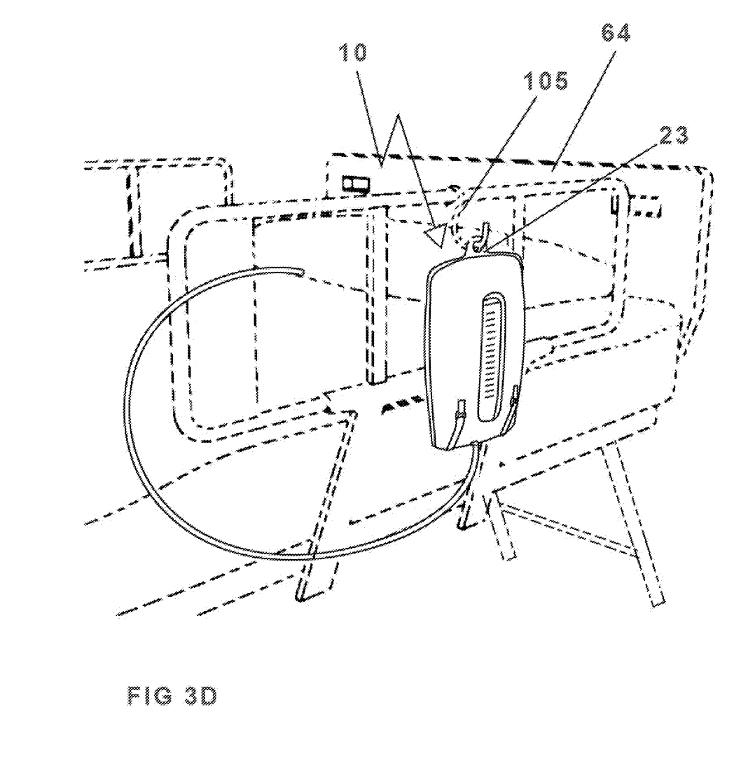

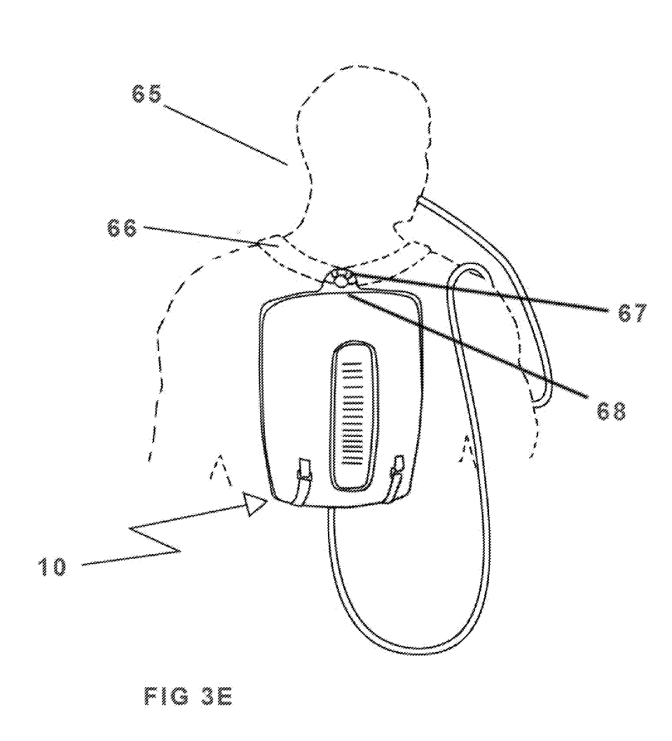

The lower portion 13 includes a tab 21 having an aperture 23 that allows the hydration system 10 to be removable installed thereonto a variety of patient care locations, such an intravenous pole 61 (reference FIG. 3A), a residential wall hook 62 (reference FIG. 3B), a wheelchair 63 (reference FIG. 3C), or a hospital bed 64 (reference FIG. 3D). Additionally, it is envisioned that the hydration system 10 can be worn by a user 65, such as by means of a harness 66 (reference FIG. 3E).

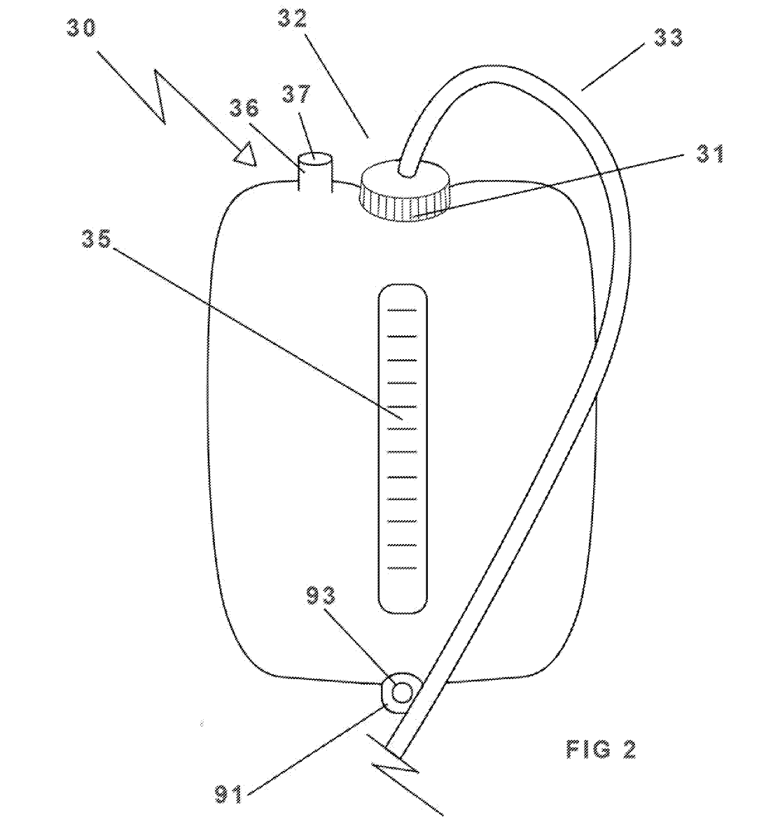

Refer now to FIG. 2, where a perspective view of the container 30 of the hydration system 10 is disclosed. The container 30 is removable from the holster 11 and has a collar 31 with a drain cap 32 to which the hydrating tube 33 is fastened. It is envisioned that the container 30 can be made of a surgical grade acrylic, polymeric or elastomeric transparent or translucent material. The scale 35 is permanently inscribed in a transparent material onto a front face portion of the container 30. The scale 35 beneficially indicates the amount of fluid taken by a user (such as the user 65 shown in FIG. 3E).

The container 30 further include a drain collar 36 closed by a drain cap 37. The drain collar beneficially has a check valve internal member which prevents fluid in the container 30 from leaking from the container 30 when the container is inverted, but selectively allows fluid to be drained from the container 30 by an operator.

In some embodiments the container 30 can include a tab 91 having an aperture 93. When the container 30 is mounted in the holster 11 (see FIG. 1) the tab 91—aperture 93 aligns with the tab 21—aperture 23 of the holster 11. In other embodiments the container 30 does not include a tab 91 and an aperture 93.

Referring now to FIG. 3A, an environmental view of the hydration system 10 removably installed thereonto the intravenous pole 61, according to the preferred embodiment of the present invention, is disclosed. The intravenous pole is depicted as standing hereupon a floor. As shown the hydration system hangs from the intravenous pole 61 via an arm 81 having a hook 83 that passes through the aperture 23 (see FIG. 1), and possibly through the aperture 93. Of course, mounting can also be achieved in a wide variety of other ways that are well known to those skilled in the applicable arts.

Referring now to FIG. 3B, an environmental view of the hydration system 10 removably installed thereonto a wall bracket 62 therewithin a health care or a residential location, according to the preferred embodiment of the present invention, is disclosed. As shown the hydration system 10 is beneficially attached to the wall bracket 62 via a hook 87 that passes through the aperture 23 (and possibly the aperture 93) and that attaches to the wall bracket 62. Of course, mounting can also be achieved in a wide variety of other ways that are well known to those skilled in the applicable arts.

Referring now to FIG. 3C, an environmental view of the hydration system 10 removably installed thereonto the wheelchair 63, according to the preferred embodiment of the present invention, is disclosed. As shown the hydration system 10 is beneficially attached to the wheelchair 63 via a hook 103 that passes through the aperture 23 and that is permanently attached to the wheelchair 63. Of course, mounting can also be achieved in a wide variety of other ways that are well known to those skilled in the applicable arts.

Referring now to FIG. 3D, an environmental view of the hydration system 10 removably installed thereonto a side rail of a hospital bed 64, according to the preferred embodiment of the present invention, is disclosed. As shown the hydration system 10 is beneficially attached to the hospital bed 64 via a hook 105 that passes through the aperture 23 and that is permanently attached to the hospital bed 64. Of course, mounting can also be achieved in a wide variety of other ways that are well known to those skilled in the applicable arts.

Refer now to FIG. 3E where an environmental view of the hydration system 10 removably installed thereonto a harness 66 worn by a user 65, according to the preferred embodiment of the present invention is shown. The harness 66 forms a ring 67 around the neck of the user 65. The hydration system is beneficially attached to the harness 66 via means of a snap ring 68 that passes through the aperture 23.

Referring now to FIG. 4A, a perspective view of an alternate fluid container 40 of the hydration system 10 according to an alternate embodiment of the present invention, is disclosed. The alternate fluid container 40 is beneficially disposable. As shown in FIG. 4A the fluid container 40 is empty, while in FIG. 4B it is shown filled with a fluid. The alternate container 40 includes a collar 43 that receives the cap 32 and the hydration tube 33 (see FIG. 4B). Because of its usefulness, the alternate fluid container 40 includes the scale 35. Furthermore, the alternate fluid container 40 may or may not include a tab 91 having an aperture 93. For convenience FIG. 4A and 4B show the tab 91. The alternate fluid container 40 is envisioned to be made of a low cost, highly flexible transparent or translucent, bio-degradable eco-friendly polymeric plastic comprising bio raw materials instead of a petro chemical.

Referring now to FIG. 4B, a perspective view of the alternate fluid container 40 of the hydration system 10 according to an alternate embodiment of the present invention, is disclosed. As noted, in FIG. 4B the alternate fluid container 40 is depicted as being filled. As such, the alternate fluid container 40 assumes a more rounded shape than that shown in FIG. 4A.

While the embodiments have been described in connection with the preferred embodiments of the various figures, it is to be understood that other similar embodiments may be used or modifications and additions may be made to the described embodiment for performing the same function without deviating therefrom. Therefore, the disclosed embodiments should not be limited to any single embodiment, but rather should be construed in breadth and scope in accordance with the appended claims.

### 2. Operation of the Preferred Embodiment

The preferred embodiments of the present invention can be utilized by a user in a simple manner with little or no training. After initial purchase or acquisition of the hydration system 10, it is assembled as generally indicated in FIG. 1 (with the holster 11 holding either the container 30 or the alternate fluid container 40).

The method of utilizing the hydration system 10 of the preferred embodiment may be achieved by performing the following steps: unfastening the pair of first straps 14 of the holster 11; opening the holster 11; removing the cap 32 from the collar 31; filling either the container 30 or the alternate fluid container 40 therewith the desired fluid (it is also possible that the alternat fluid container was prefilled); securing the cap 32; passing the mouth piece 34 and the hydrating tube 33 therethrough the aperture 18; installing the filled fluid container 30 or alternate fluid container 40 hereinto the holster 11; closing the holster 11; securing the closing of the holster 11 by fastening each of the pair of the first straps 14; selecting an installation location; inverting the hydration system 10; removably installing the hydration system 10 in the chosen installation location (for example, as shown in FIG. 3A-3E), routing the hydrating tube 33 to the user which enables the user to selectively obtain hydration by biting the mouth piece 34. When the hydration system is depleted of fluid an operator remove the holster 11 from its installation location, remove the cap 32. then either refill the container 30 or replace the alternative fluid container 40 (depending on which container is being used). Replacement is performed by unfastening the pair of first straps 14 of the holster 11; opening the holster 11; removing the fluid container from the holster 11; installing a replacement filled alternative fluid container 40, and refastening it in place.

Beneficially a container 30 can be emptied of residual fluid by removing the cap 37. This can be performed with the hydration system 10 in its installation location without requiring an operator to lift a full hydration system 10.

The method of installing and uninstalling the alternate fluid container 40 may be achieved by following steps similar to those followed in installing and uninstalling the fluid container 30 of the preferred embodiment 10. After use, the empty alternate container 41 is discarded.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

What is claimed is:

1. A hydration system, comprising:
a holster having a portion that defines a container-retention volume;
a fluid container within said container-retention volume;
a hydrating tube extending from, and in fluid communication with, said fluid container; and
a mouthpiece in fluid communication with said hydrating tube;
wherein said holster further includes means for retaining said container within said container-retention volume.

2. A hydration system according to claim 1, wherein said retaining means comprises pair of first straps, a pair of second straps, and a pair of buckles for connecting said pair of first straps to said pair of second straps.

3. A hydration system according to claim 1, further including a graduated scale for indicating an amount of fluid in said fluid container.

4. A hydration system according to claim 1, further including a scale indicating an amount of fluid removed from said fluid container.

5. A hydration system according to claim 3, further including a window for viewing said scale.

6. A hydration system according to claim 1, wherein said holster includes a mount means for mounting said hydration system in an operational location.

7. A hydration system according to claim 1, wherein said mount means includes an aperture.

8. A hydration system according to claim 1, wherein said fluid container includes a drain for enabling fluid drainage from said fluid container.

9. A hydration system according to claim 1, wherein said fluid container is disposable.

10. A hydration system according to claim 1, wherein said mouthpiece enables fluid flow based on a user drawing a vacuum.

11. A hydration system according to claim 1, wherein said mouthpiece enables fluid flow when a user bites said mouthpiece.

12. A hydration system, comprising:
a holster having a container-retention volume that encloses a fluid container, a hydrating tube extending from and in fluid communication with said fluid container, and a mouthpiece in fluid communication with said hydrating tube, wherein said holster further includes means for mounting said holster in an operational location; and
a mount attached to support;
wherein said support mounts said holster to a location adjacent a user.

13. A hydration system according to claim 12, wherein said support is an intravenous pole.

14. A hydration system according to claim 12, wherein said support is a wall, and wherein said mount includes a wall bracket.

15. A hydration system according to claim 12, wherein said support is a wheelchair.

16. A hydration system according to claim 12, wherein said support is a hospital bed.

17. A hydration system according to claim 12, wherein said support is a collar around a patient.

18. A hydration system, comprising:
a holster having a container-retention volume that encloses a fluid container with a scale, said holster further including a window for enabling viewing of said scale;
a hydrating tube extending from and in fluid communication with said fluid container; and
a mouthpiece in fluid communication with said hydrating tube,
wherein said holster further includes means for mounting said holster in an operational location.

19. A hydration system according to claim 18, wherein said mouthpiece enables fluid flow based on a user drawing a vacuum.

20. A hydration system according to claim 1, wherein said mouthpiece enables fluid flow when a user bites said mouthpiece.
